(19) United States
(12) Patent Application Publication
(10) Pub. No.: US 2014/0132800 A1
(43) Pub. Date: May 15, 2014

(54) IMAGE PROCESSING APPARATUS AND IMAGE PROCESSING METHOD

(71) Applicant: CANON KABUSHIKI KAISHA, Tokyo (JP)

(72) Inventor: Hidetoshi Onuma, Yokohama-shi (JP)

(73) Assignee: CANON KABUSHIKI KAISHA, Tokyo (JP)

(21) Appl. No.: 14/067,306

(22) Filed: Oct. 30, 2013

(30) Foreign Application Priority Data
Nov. 9, 2012 (JP) 2012-247034

(51) Int. Cl. H04N 5/76

(52) U.S. Cl. CPC H04N 5/76
USPC 348/231.3

(57) ABSTRACT

An image processing apparatus includes a memory storing image data and information data of plural layers to be combined on the image data, a first combination unit to generate first combined image data, and a second combination unit to generate second combined image data, the plurality of layers including a common layer containing information data used for both the first and second combined image data, and a unique layer containing information data used for one of the first and second combined image data and not used for the other, outputs first information data of the common layer from the memory to both units, outputs second information data for the first combined image data from the memory to the first combination unit, and outputs third information data for the second combined image data from the memory to the second combination unit.

### BACKGROUND OF THE INVENTION

1. Field of the Invention

The present invention relates to an image processing apparatus and, more particularly, to an apparatus which performs combination of images by using a memory.

2. Description of the Related Art

Conventionally, an image processing apparatus built in a digital camera has a function of displaying a captured image on a built-in display unit such as a liquid crystal monitor and outputting it to an external display device or the like. In recent years, image pickup apparatuses capable of capturing a full-HD (High Definition) moving image at 60 frames per sec with 1920×1080 pixels have appeared on the market.

When displaying a captured image on the built-in display unit, various types of information such as information of a photographing state, including the time elapsed after the start of recording and an amount of remaining capacity of a recording medium, various icons, and a frame for checking framing are superimposed on the photographed image.

To the contrary, information different from one to be superimposed on a captured image to be displayed on the built-in display unit is sometimes superimposed on an image to be output outside.

When superimposing various types of information on an image to be displayed, it is common practice to temporarily store image data in a memory and then perform a superimposition process in the memory (see, e.g., Japanese Patent Application Laid-Open No. 2010-204262).

The digital camera generates an image to be recorded on a recording medium, in addition to an image to be displayed on the built-in display unit and an image to be output outside. The video camera needs to substantially simultaneously generate these images from a captured image depending on the situation. As the number of pixels of a handled image increases, a wider memory band and higher processing ability are required.

Under this circumstance, a conventional technique requires image processing units correspondingly to the number of images which need to be generated simultaneously, that is, layer image combination units are required by a total number of so-called layers. To match the output timings of images to the built-in display unit and external display device, the layer image combination units need to be equipped with line memories for temporarily storing image data. All of these increase the circuit scale and raise the cost.

### SUMMARY OF THE INVENTION

The present invention presents an image processing apparatus which lightens the processing ability in a case where generating a plurality of images are generated by superimposing partially different information based on the same image.

An image processing apparatus according to the present invention comprises a memory configured to store image data and information data of a plurality of layers to be combined on the image data, a memory control unit configured to control the memory, a first combination unit configured to combine the information data of the plurality of layers read out from the memory on the image data read out from the memory and generate first combined image data, a second combination unit configured to combine the information data of the plurality of layers read out from the memory on the image data read out from the memory and generate second combined image data, the plurality of layers including a common layer containing information data used for both the first combined image data and the second combined image data, and a unique layer containing information data used for one of the first combined image data and the second combined image data and not used for the other one of the first combined image data and the second combined image data, and a control unit configured to control the memory control unit so as to output first information data of the common layer from the memory to both the first combination unit and the second combination unit, wherein the control unit controls the memory control unit with respect to the unique layer so as to output second information data for the first combined image data from the memory to the first combination unit, and output third information data for the second combined image data from the memory to the second combination unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram showing the schematic arrangement of an image pickup apparatus according to an embodiment of the present invention.

FIG. 2 is an explanatory view showing a concept of layer combination.

FIG. 3 is a block diagram showing the schematic arrangement of an image combination unit.

FIG. 4 is a view showing an explanatory example of two image combinations using partially different data as combination targets.

FIG. 5 is a block diagram showing the schematic arrangement of a synchronization control unit.

FIG. 6 is a block diagram showing a schematic arrangement to explain the flow of data from a memory control unit to the image combination unit in a band reduction mode.

### DESCRIPTION OF THE EMBODIMENTS

Various exemplary embodiments, features, and aspects of the present invention will be described in detail below with reference to the drawings.

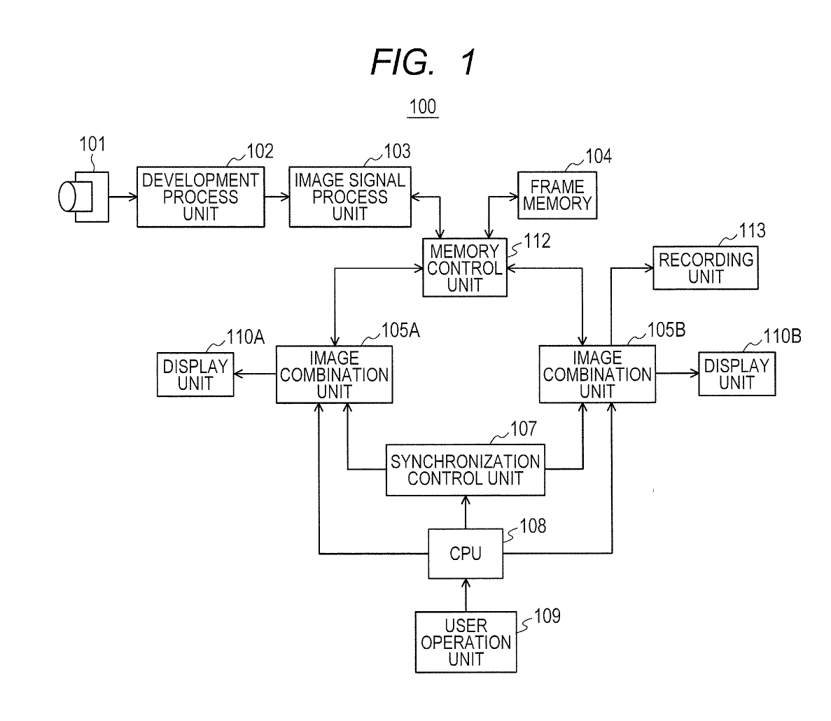

FIG. 1 is a block diagram showing the schematic arrangement of an image pickup apparatus 100 to which an embodiment of an image processing apparatus according to the present invention is applied. The image pickup apparatus 100 includes an image pickup unit 101, development process unit 102, image signal process unit 103, and frame memory 104. The image pickup apparatus 100 also includes image combination units 105A and 105B, a synchronization control unit 107, a CPU 108, a user operation unit 109, display units 110A and 110B, and a memory control unit 112 configured to control write and read-out of data in and from the frame memory 104.

The image pickup unit 101 supplies moving image data generated from an optical image of an object to the development process unit 102. In the embodiment, the image pickup unit 101 outputs moving image data of 60 frames per sec in which the number of pixels of one frame is 1920×1080 pixels. The development process unit 102 performs a development process to the moving image data from the image pickup unit 101, and the image signal process unit 103 performs a predetermined image process to the moving image data output from the development process unit 102. The image signal process unit 103 issues a request to the memory control unit 112 to transfer the moving image data to the frame memory 104. The memory control unit 112 stores the moving image data in the frame memory 104 in accordance with the request from the image signal process unit 103. In the present embodiment, the frame memory 104 has a capacity capable of storing moving image data of at least two frames and image data of each layer (to be described later). A recording unit 113 records moving image data from the image combination unit 105A on a recording medium.

The user operation unit 109 includes a power switch and an operation key for designating the start and stop of recording, or various operation members for setting the state of the image pickup apparatus 100 by means of menu display or the like. By operating the user operation unit 109, the user can instruct the CPU 108 to determine whether to output moving image data to the display units 110A and 110B. In accordance with the instruction from the user, the CPU 108 determines whether an access band reduction mode to the frame memory 104 by the image combination units 105A and 105B is possible. In the band reduction mode, the image combination units 105A and 105B are controlled by the synchronization control unit 107 based on the same timing signal, and operate in cooperation with each other. If the image combination units 105A and 105B cannot be operated in the band reduction mode, they are controlled respectively by independent timing signals from the synchronization control unit 107 to be operated independently. An output image from the image combination unit 105A is supplied to the display unit 110A. An output image from the image combination unit 105B is supplied to the display unit 110B and recording unit 113.

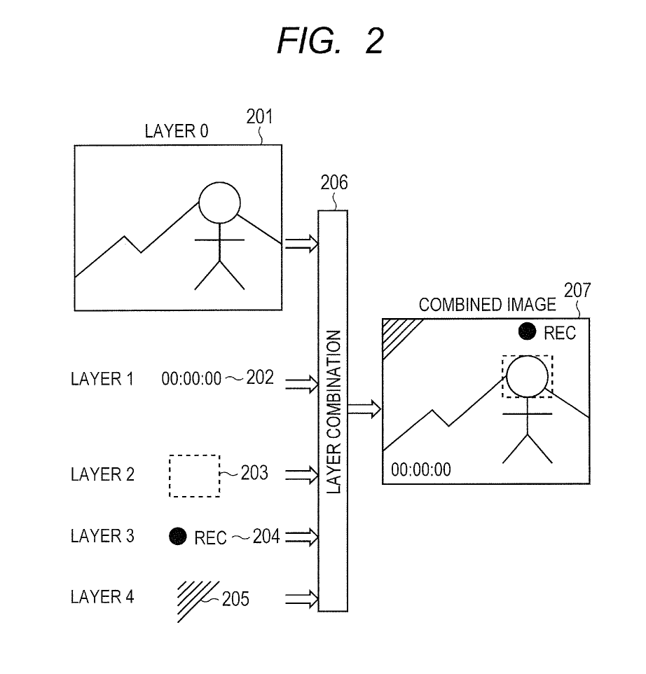

A concept of combination by the image combination units 105A and 105B will be explained with reference to FIG. 2. A layer combination unit 206 combines layer data of subjects 201 to 205, and outputs a combined image 207. The subject 201 of layer 0 is a moving image from the image pickup unit 101. The subject 202 of layer 1 is the time, e.g., the time elapsed after the start of recording a moving image. The subject 203 of layer 2 is a frame indicating a specific portion, e.g., a frame indicating the region of a face image recognized in each frame of a moving image from the image pickup unit 101. The subject 204 of layer 3 is an icon/character indicating that an image is being recorded. The subject 205 of layer 4 is a decoration or the like to be superimposed on a moving image from the image pickup unit 101. The frame memory 104 can store information data of these layers.

The CPU 108 generates image data of each layer and outputs it to the memory control unit 112. The memory control unit 112 receives the image data of each layer from the CPU 108, and writes it at an address designated by the CPU 108 in the frame memory 104. In the present embodiment, since moving image data from the image pickup unit 101 is used as image data of layer 0, the CPU 108 generates information data of layers other than layer 0. The CPU 108 sends information about the write address of the image data of each layer to the image combination units 105A and 105B.

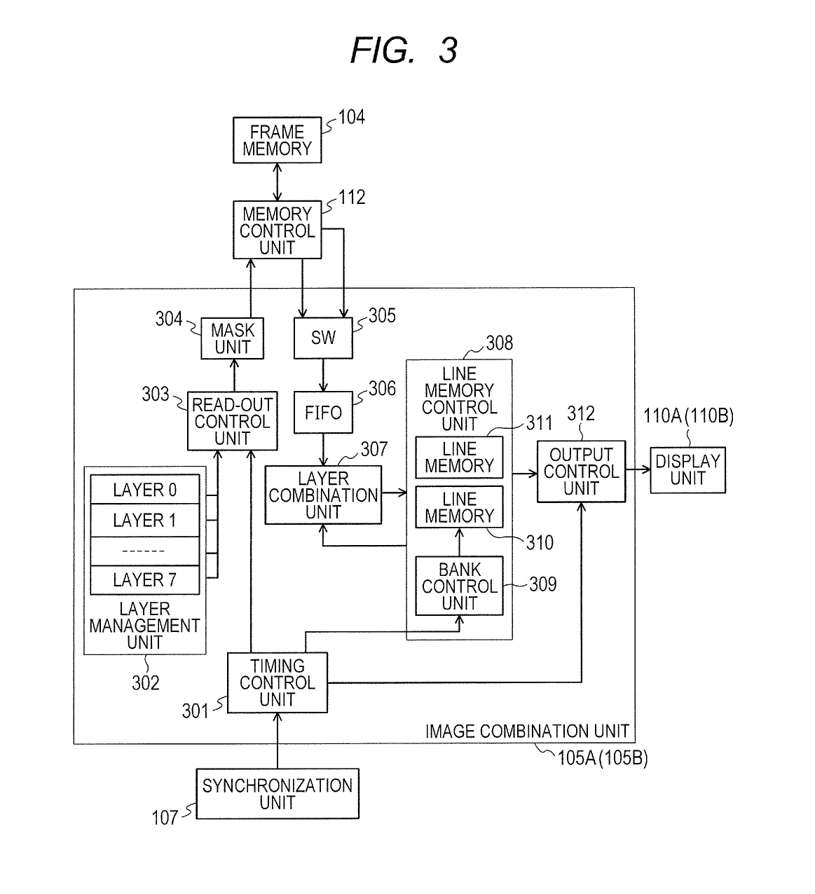

FIG. 3 is a block diagram showing the schematic arrangement of the image combination units 105A and 105B. The image combination units 105A and 105B have the same arrangement structure.

Each of the image combination units 105A and 105B includes a timing control unit 301, layer management unit 302, read-out control unit 303, request mask control unit 304, signal switching unit 305, FIFO 306, and layer combination unit 307. Each of the image combination units 105A and 105B also includes a line memory control unit 308, a bank control unit 309, line memories 310 and 311, and an output control unit 312.

The timing control unit 301 receives, from the synchronization control unit 107, a timing signal for performing a process on a line basis. The layer management unit 302 stores the write address of image data of each layer in the frame memory 104, that is sent from the CPU 108. In accordance with the timing signal from the timing control unit 301, the read-out control unit 303 acquires address information of each layer in the frame memory 104 from the layer management unit 302. Then, the read-out control unit 303 designates the address of image data in order from layer 0 on the line basis and issues, to the request mask control unit 304, an access request directed to the frame memory 104. The request mask control unit 304 determines whether to issue or stop the access request from the read-out control unit 303 to the memory control unit 112. When the access request is issued, the memory control unit 112 transfers image data read out from the frame memory 104 to the signal switching unit 305. The signal switching unit 305 has two input ports connected to the memory control unit 112, and selects data from one input port to transfer it to the FIFO 306. The FIFO 306 temporarily stores the image data from the signal switching unit 305 which is read out from the frame memory 104.

The layer combination unit 307 combines the image data stored in the FIFO 306 and image data read out from the line memory control unit 308. The image data combined by the layer combination unit 307 is written back again in the line memory control unit 308. The line memory control unit 308 is formed from the line memories 310 and 311 and the bank control unit 309. In accordance with a timing signal which is output from the timing control unit 301 and designates the start of a line, the bank control unit 309 uses one of the line memories 310 and 311 for output and the other one for image combination. The output control unit 312 outputs data read out from the line memory control unit 308 to the display units 110A and 110B in accordance with a timing signal from the timing control unit 301.

For example, when images of layers 0 to 7 are to be combined for one line, the memory control unit 112 sequentially reads out image data of layers 0 to 7 to be combined for one line, and combines them. More specifically, the layer management unit 302 instructs the memory control unit 112 to read out image data of layer 0 of one line, and the memory control unit 112 reads out image data of layer 0 of one line. Then, the read-out image data of layer 0 is written in the line memory 311 of the line memory control unit 308 via the FIFO 306 and layer combination unit 307.

Subsequently, the memory control unit 112 reads out image data of layer 1 of the same line and writes it in the FIFO 306. The layer combination unit 307 combines the image data of one line read out from the line memory 311 and the image data of layer 1 from the FIFO 306, and writes the combined image data again in the line memory 311. In the same manner, image data of layers 2 to 7 of the same line are sequentially read out from the frame memory 104 and combined by the layer combination unit 307. After image data of up to layer 7 are combined, the combined image data is written in the line memory 310, sequentially read out from the line memory 310 by the output control unit 312, and output to the display unit 110A.

Upon completion of combination and display of image data of one line, the same process is executed for the next line.

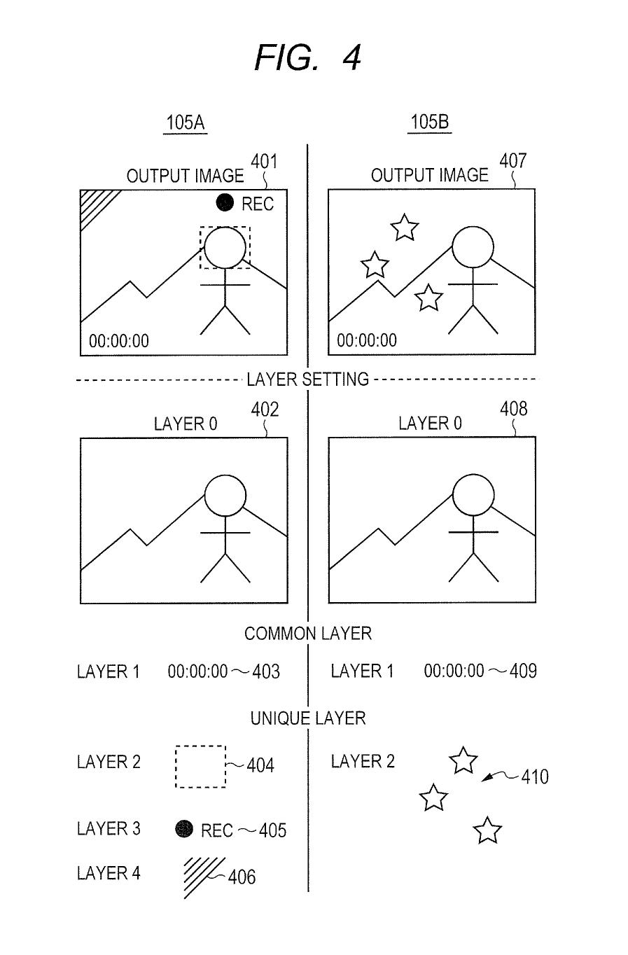

A layer assignment operation in the band reduction mode operation will be explained with reference to FIG. 4. Reference numeral 401 denotes an example of an output image of the image combination unit 105A. Reference numeral 402 denotes an example of an image of layer 0 serving as a subject for generating the output image 401 by the image combination unit 105A. Reference numeral 403 denotes an example of an image of layer 1 serving as a subject for generating the output image 401 by the image combination unit 105A. Reference numeral 404 denotes an example of an image of layer 2 serving as a subject for generating the output image 401 by the image combination unit 105A. Reference numeral 405 denotes an example of an image of layer 3 serving as a subject for generating the output image 401 by the image combination unit 105A. Reference numeral 406 denotes an example of an image of layer 4 serving as a subject for generating the output image 401 by the image combination unit 105A.

Reference numeral 407 denotes an example of an output image of the image combination unit 105B. Reference numeral 408 denotes an example of an image of layer 0 serving as a subject for generating the output image 407 by the image combination unit 105B. Reference numeral 409 denotes an example of an image of layer 1 serving as a subject for generating the output image 407 by the image combination unit 105B. Reference numeral 410 denotes an example of an image of layer 2 serving as a subject for generating the output image 407 by the image combination unit 105B.

When generating the output images 401 and 407, a common subject layer will be called a common layer, and layers unique to the respective output images 401 and 407 will be called unique layers. According to the present embodiment, in the band reduction mode, a common layer is arranged first and a unique layer is arranged next.

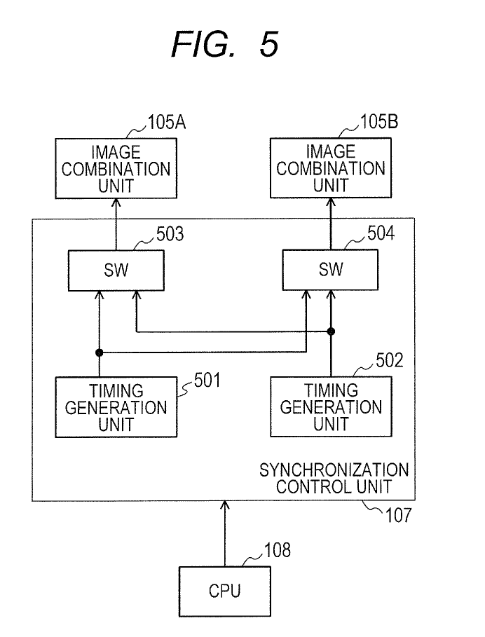

FIG. 5 is a block diagram showing the schematic arrangement of the synchronization control unit 107. Reference numerals 501 and 502 denote timing generation units which generate a timing signal; and 503 and 504, signal switching units. The signal switching unit 503 selects a timing signal to control the image combination unit 105A. The signal switching unit 504 selects a timing signal to control the image combination unit 105B. When the image combination units 105A and 105B are to be operated in the band reduction mode, the CPU 108 controls the signal switching units 503 and 504 to control the image combination units 105A and 105B by the same one of the timing generation units 501 and 502.

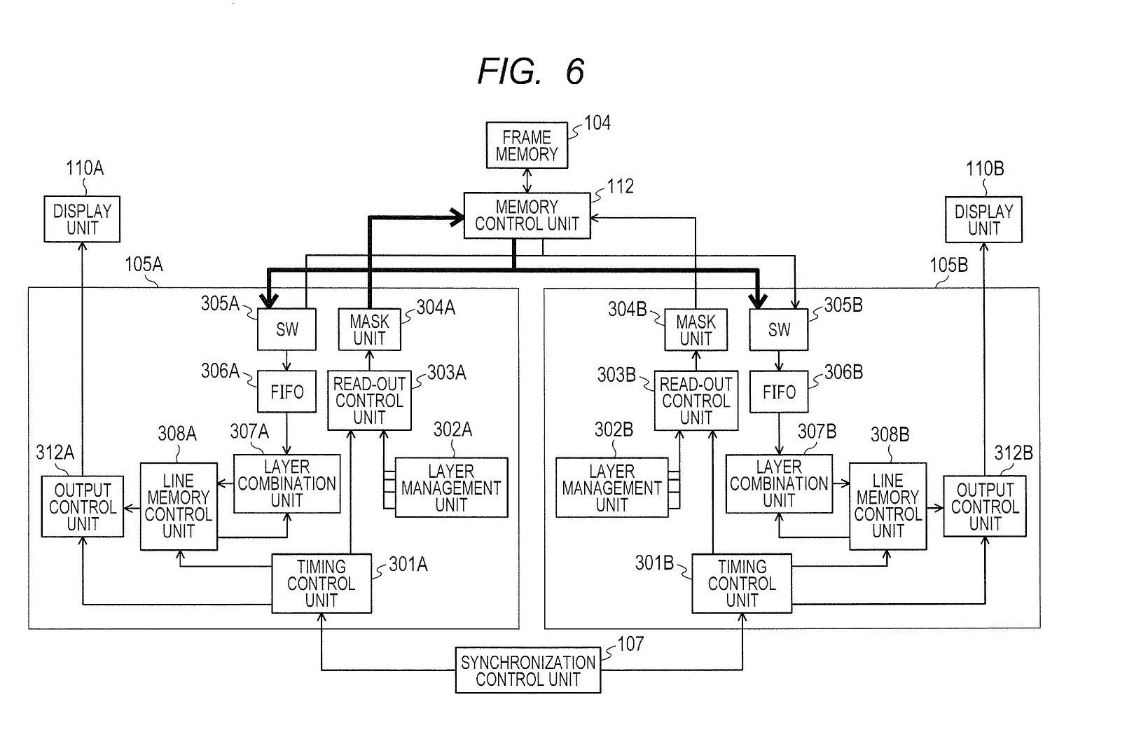

FIG. 6 shows data flows between the memory control unit 112 and the signal switching units of the image combination units 105A and 105B in the band reduction mode. Thick solid lines indicate the data flows. Note that a letter is added to the reference numerals described with reference to FIG. 3 for the building components of the image combination unit 105A, and a letter “B” is added to the reference numerals described with reference to FIG. 3 for the building components of the image combination unit 105B. As the building components of the image combination units 105A and 105B, only those necessary for understanding are illustrated, and the remaining ones are not illustrated.

By using the user operation unit 109, the user sets the conditions of images to be output to the image combination units 105A and 105B, and notifies the CPU 108 of them or sets them in the CPU 108. Based on output image information of the image combination units 105A and 105B, the CPU 108 determines whether the image combination units 105A and 105B can operate in the band reduction mode. To operate in the band reduction mode, the following four conditions need to be satisfied. The first condition is that the sizes (numbers of pixels) of image data to be output from the image combination units 105A and 105B are equal. The second condition is that the frame rates of image data to be output from the image combination units 105A and 105B are equal. The third condition is that layer assignment to arrange a unique layer after a common layer is possible. The fourth condition is that the output timing of image data generated by the image combination unit 105A and that of image data generated by the image combination unit 105B can match each other.

If these four conditions are satisfied, the synchronization control unit 107 supplies the same timing signal generated by the timing generation unit 501 (or 502) to the image combination units 105A and 105B. The image combination unit 105A reads out image data in order from layer 0 and performs combination of images. To the contrary, in the image combination unit 105B, an operation in a case where an image of a common layer is combined, and an operation in a case where an image of a unique layer is combined are different.

More specifically, in a case where an image of a common layer is combined, the request mask control unit 304B masks an access request to the memory control unit 112. Then, the signal switching unit 305B supplies, to the FIFO 306B, image data read out from the frame memory 104 in accordance with an access request issued by the image combination unit 105A.

In a case where an image of a unique layer is combined, the request mask control unit 304B supplies an access request from the read-out control unit 303 to the memory control unit 112. Then, the signal switching unit 305B supplies, to the FIFO 306B, image data read out from the frame memory 104 in accordance with an access request issued by the image combination unit 105B.

This operation can reduce memory accesses for a portion corresponding to a common layer.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2012-247034 filed on Nov. 9, 2012, which is hereby incorporated by reference herein in its entirety.

What is claimed is:

1. An image processing apparatus comprising:
a memory configured to store image data and information data of a plurality of layers to be combined on the image data;
a memory control unit configured to control the memory;
a first combination unit configured to combine the information data of the plurality of layers read out from the memory on the image data read out from the memory and generate first combined image data;
a second combination unit configured to combine the information data of the plurality of layers read out from the memory on the image data read out from the memory and generate second combined image data, the plurality of layers including a common layer containing information data used for both the first combined image data and the second combined image data, and a unique layer containing information data used for one of the first combined image data and the second combined image data and not used for the other one of the first combined image data and the second combined image data; and
a control unit configured to control the memory control unit so as to output first information data of the common layer from the memory to both the first combination unit and the second combination unit,
wherein the control unit controls the memory control unit with respect to the unique layer so as to output second information data for the first combined image data from the memory to the first combination unit, and output third information data for the second combined image data from the memory to the second combination unit.

2. An apparatus according to claim 1, wherein the control unit controls the memory control unit so as to read out the first information data of the common layer from the memory, and output the first information data to the first combination unit and the second combination unit at the same timing.

3. An apparatus according to claim 1, wherein the control unit controls the memory control unit with respect to the unique layer so as to output the second information data and the third information data from the memory at different timings.

4. An apparatus according to claim 1, wherein each of the first combination unit and the second combination unit combines the image data and the information data of the plurality of layers on the line basis.

5. An apparatus according to claim 4, wherein
each of the first combination unit and the second combination unit combines the image data of one line and first information data of the common layer of one line,
the first combination unit combines second information data of the unique layer of one line on image data in which the image data of one line and the first information data are combined, thereby generating the first combined image data of one line, and
the second combination unit combines third information data of the unique layer of one line on the image data in which the image data of one line and the first information data are combined, thereby generating the second combined image data of one line.

6. An apparatus according to claim 4, wherein each of the first combination unit and the second combination unit includes a plurality of line memories arranged to store image data of one line.

7. An apparatus according to claim 1, further comprising:
a first output unit configured to output the first combined image data generated by the first combination unit to a first display unit; and
a second output unit configured to output the second combined image data generated by the second combination unit to a second display unit.

8. An apparatus according to claim 1, wherein
the control unit outputs the same timing signal to the first combination unit and the second combination unit, and
the first combination unit and the second combination unit operate in accordance with the timing signal.

9. An image processing method comprising:
a storage step of storing, in a memory, image data and information data of a plurality of layers to be combined on the image data;
a memory control step of controlling the memory;
a first combination step of combining the information data of the plurality of layers read out from the memory on the image data read out from the memory and generating first combined image data;
a second combination step of combining the information data of the plurality of layers read out from the memory on the image data read out from the memory and generating second combined image data, the plurality of layers including a common layer containing information data used for both the first combined image data and the second combined image data, and a unique layer containing information data used for one of the first combined image data and the second combined image data and not used for the other one of the first combined image data and the second combined image data; and
a control step of controlling a memory control step so as to output first information data of the common layer from the memory to both the first combination step and the second combination step,
wherein the control step controls the memory control unit with respect to the unique layer so as to output second information data for the first combined image data from the memory to the first combination step, and output third information data for the second combined image data from the memory to the second combination step.
